(19) United States
(12) Patent Application Publication
(10) Pub. No.: US 2006/0101105 A1
(43) Pub. Date: May 11, 2006

(54) Double shift mechanism and methods thereof

(76) Inventors: Roy Glasner, Ramat Gan (IL); Samuel Kertser, Rishon LeZion (IL)

Correspondence Address: PEARL COHEN ZEDEK, LLP, 1500 BROADWAY 12TH FLOOR, NEW YORK, NY, 10036, US

(21) Appl. No.: 10/984,859

(22) Filed: Nov. 10, 2004

(51) Int. Cl. G06F 15/00

(52) U.S. Cl. 708/200

(57) ABSTRACT

In a processor, a concatenation of contents of two registers having a fixed number of one-bit data storage elements are shifted by a software-defined, controllable amount and the fixed number of bits are selected from the shifted concatenation as output.

### BACKGROUND OF THE INVENTION

A machine on an integrated circuit may have a fixed data width, for example, 32 bits. In such a machine, registers may have a fixed number of one-bit data storage elements However, certain applications may involve the handling of data that is stored partly in one register and partly in another register.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a block diagram of an exemplary device including a processor coupled to a data memory and to a program memory, according to some embodiments of the invention;

FIG. 2 is a block diagram of an exemplary shift unit, according to an embodiment of the invention;

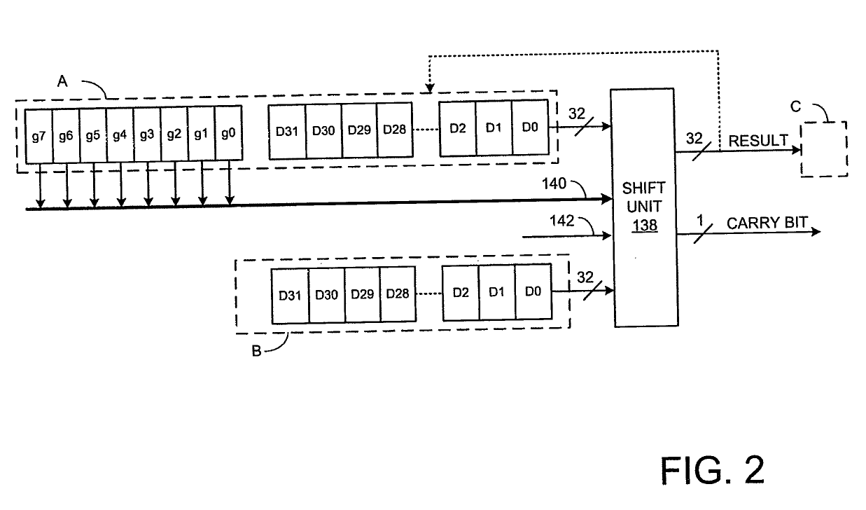

FIG. 3 is a flowchart of exemplary method for extracting variable-size bit-strings from a bit stream using “double-shift right” operations, according to an embodiment of the invention;

FIGS. 4A-4G are diagrams showing the contents of registers at various stages of the method of FIG. 3;

FIG. 5 is a flowchart of an exemplary method in which a “double-shift right” operation is used to generate an N-bits truncated execution result of division of a 2N-bit operand by a number which is a power of two, according to an embodiment of the invention; and

FIG. 6 is a flowchart of an exemplary method in which a “double-shift left” operation is used to generate an N-bits truncated execution result of multiplication of a 2N-bit operand by a number which is a power of two, according to an embodiment of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

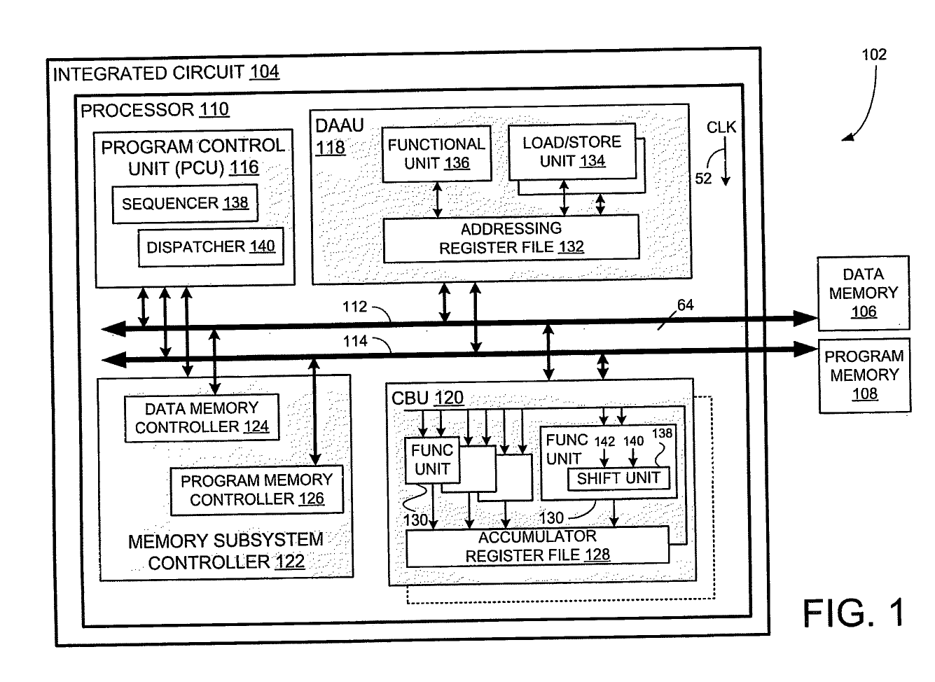

FIG. 1 is a block diagram of an exemplary apparatus 102 including an integrated circuit 104, a data memory 106 and a program memory 108. Integrated circuit 104 includes an exemplary processor 110 that may be, for example, a digital signal processor (DSP), and processor 110 is coupled to data memory 106 via a data memory bus 112 and to program memory 108 via a program memory bus 114. Data memory 106 and program memory 108 may be the same memory or alternatively, separate memories An exemplary architecture for processor 110 will now be described, although other architectures are also possible. Processor 110 includes a program control unit (PCU) 116, a data address and arithmetic unit (DAAU) 118, one or more computation and bit-manipulation units (CBU) 120, and a memory subsystem controller 122. Memory subsystem controller 122 includes a data memory controller 124 coupled to data memory bus 112 and a program memory controller 126 coupled to program memory bus 114. PCU 116 is to retrieve, pre-decode and dispatch machine language instructions and is responsible for the correct program flow. CBU 120 includes an accumulator register file 128 and functional units 130, having any of the following functionalities or combinations thereof: multiply-accumulate (MAC), add/subtract, bit manipulation, arithmetic logic, and general operations. DAAU 118 includes an addressing register file 132, a functional unit 136 having arithmetic, logical and shift functionality, and load/store units (LSU) 134 capable of loading and storing data chunks from/to data memory 106.

One functional unit 130 includes a shift unit 138, which is described in more detail hereinbelow. The inputs and outputs of shift unit 138 are coupled to accumulator register file 128. (In other embodiments, functional units 130 may have fixed input registers and/or fixed output registers.)

In the example shown in FIG. 1, one functional unit of processor 110 includes a shift unit according to an embodiment of the invention. In other examples, the processor may include a different number of functional units each having one or more instances of a shift unit according to an embodiment of the invention. For example, the processor may include two or four functional units each having a shift unit according to an embodiment of the invention.

Processor 110 may contain registers having a fixed number N of one-bit data storage elements. A one-bit data storage element may be, for example, a latch, a flip-flop or a memory cell. For example, accumulator register file 128 may contain registers A and B, each having 32 one-bit data storage elements (N=32). This is merely an example, and a register may include any other fixed number of one-bit data storage elements.

In the following description, data storage elements of register A are denoted A/D0 to A/D31, and data storage elements of register B are denoted B/D0 to B/D31, where the least significant bit (LSB) is D0 and the most significant bit (MSB) is D31.

Processor 110 may be able to perform operations on data partly stored in [A/D31 . . . A/D0] and partly stored in [B/D31 . . . B/D0].

For example, shift unit 138 may execute a “double-shift left” operation on data partly stored in [A/D31 . . . A/D0] and partly stored in [B/D31 . . . B/D0], the result of which is equivalent to performing the following sequence of operations:

a) Concatenate the contents of the data storage elements of register A with the contents of the data storage elements of register B to generate a value [A/D31, A/D0, B/D31 . . . B/D0] of length 2N, e.g. 64 bits.

b) Generate a shifted 2N-bit value by shifting the 2N-bit value by one bit a predefined number of times toward its MSB. For example, a shift of the 64-bit value by one bit once toward its MSB will generate the 64-bit value [A/D30 . . . A/D0, B/D31 . . . B/D0, x], where “x” may be undefined. In another example, a shift of the 64-bit value by one bit twice toward its MSB will generate the 64-bit value [A/D29 . . . A/D0, B/D31 . . . B/D0, x, y], where “x” and “y” may be undefined.

c) Generate at least a one-bit carry flag, and an execution result equal to the N most significant bits of the shifted 2N-bit value. For the example in which the shifted 64-bit value equals [A/D30 . . . A/D0, B/D31 . . . B/D0, x], the carry flag equals A/D31 and the execution result equals [A/D30 . . . A/D0, B/D31]. For the example in which the shifted 64-bit value equals [A/D29 . . . A/D0, B/D31 . . . B/D0, x, y], the carry flag equals A/D30 and the execution result equals [A/D29 . . . A/D0, B/D31 . . . B/D30].

Processor 110 may perform this “double-shift left” operation in a single instruction cycle or a single clock cycle.

In another example, processor 110 may execute a “double-shift right” operation on data partly stored in [A/D31 . . . A/D0] and partly stored in [B/D31 . . . B/D0], the result of which is equivalent to performing the following sequence of operations:

a) Concatenate the contents of the data storage elements of register A with the contents of the data storage elements of register B to generate a value [A/D31 . . . A/D0, B/D31 . . . B/D0] of length 2N, e.g. 64 bits.

b) Generate a shifted 2N-bit value by shifting the 2N-bit value by one bit a predefined number of times toward its LSB. For example, a shift of the 64-bit value by one bit once toward its LSB will generate the 64-bit value [x, A/D31 . . . A/D0, B/D31 . . . B/D1], where “x” may be undefined. In another example, a shift of the 64-bit value by one bit twice toward its LSB will generate the 64-bit value [y, x, A/D31 . . . A/D0, B/D31 . . . B/D2], where “x” and “y” may be undefined.

c) Generate at least a one-bit carry flag, and an execution result equal to the N least significant bits of the shifted 2N-bit value. For the example in which the shifted 64-bit value equals [x, A/D31 . . . A/D0, B/D31 . . . B/D1], the carry flag equals B/D0 and the execution result equals [A/D0, B/D31 . . . B/D1]. For the example in which the shifted 64-bit value equals [y, x, A/D31 . . . A/D0, B/D31 . . . B/D2], the carry flag equals B/D1 and the execution result equals [A/D1, A/D0, B/D31 . . . B/D2].

Processor 10 may perform this “double-shift right” operation in a single instruction cycle or a single clock cycle.

Shift unit 138 may receive bits [A/D31 . . . A/D0] and bits [B/D31 . . . B/D0] and may generate execution results and carry bits for the “double-shift left” and “double-shift right” operations. Although the invention is not limited in this respect, shift unit 138 may include a barrel shifter. The barrel shifter may have at least twice the fixed number of one-bit data storage elements as the registers in accumulator register file 128.

Shift unit 138 may receive control signals 140. The value of control signals 140 may control shift unit 138 to execute a “double-shift left” operation or a “double-shift right” operation, and may determine the number of times a one-bit shift would be performed to achieve the desired operation.

For example, if the value of control signals 140 is positive, shift unit 138 may execute a “double-shift left” operation equivalent to a shift of the value of control signals 140. In another example, if the value of control signals 140 is negative, shift unit 138 may execute a “double-shift right” operation equivalent to a shift of the absolute value of control signals 140. In a further example, shift unit 138 may in addition receive a signal 142. If the value of control signals 140 equals zero, the value of signal 142 may determine whether shift unit 138 outputs the value [A/D31 . . . A/D0] or the value [B/D31 . . . B/D0] as the execution result.

According to some embodiments of the invention, the value of control signals 140 and signal 142 may be defined by software. Although the invention is not limited in this respect, register A may include guard bits for example, 8 guard bits denoted g0 to g7. Control signals 140 may carry the values of guard bits g0 to g7. Accordingly, software may alter the values of guard bits g0 to g7 to define the values of control signals 140. Alternatively, control signals 140 and signal 142 may carry the values of bits stored elsewhere.

Optionally, accumulator register file 128 may include a register C having N one-bit data storage elements (e.g 32), to receive and store execution results of “double-shift left” and “double-shift right” operations from shift unit 138. Alternatively, an execution result of a “double-shift left” or a “double-shift right” operation may be stored in register A or register B.

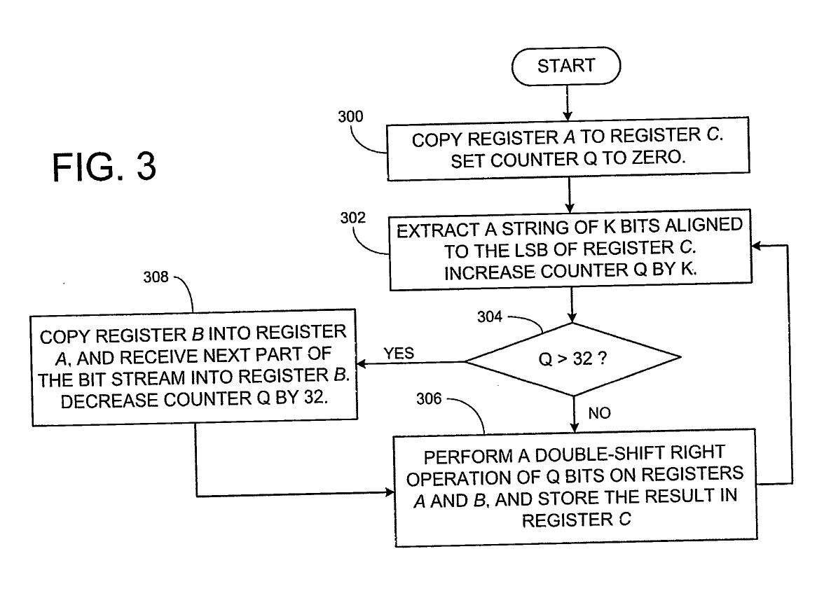

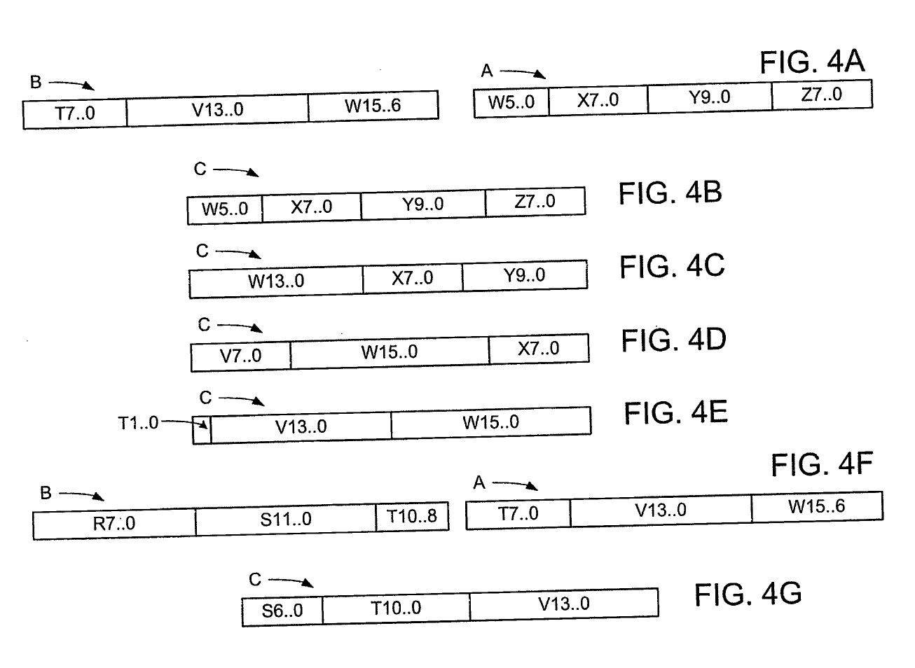

“Double-shift left” and “double-shift right” operations can be used as part of different methods to be performed by processor 110. For example, FIG. 3 presents an exemplary method for extracting variable-size bit-strings from a bit-stream using “double-shift right” operations. Reference is also made to FIGS. 4A-4G, which show the contents of registers A and B at various stages of the method of FIG. 3.

Processor 110 may receive a bit stream that may contain information related to, for example, data, audio, video or a combination thereof. The bit stream may include bit-strings of different sizes.

For example, processor 110 may receive a bit stream that includes an 8-bit bit-string [Z7 . . . 0], followed by a 10-bit bit-string [Y9 . . . 0], followed by an 8-bit bit-string [X7 . . . 0], followed by a 16-bit bit-string [W15 . . . 0], followed by a 14-bit bit-string [V13 . . . 0], followed by an 11-bit bit-string [T10 . . . 0], followed by a 12-bit bit-string [S11 . . . 0], followed by an 11-bit bit-string [R10 . . . 0]. In the interests of clarity, other bit-strings that may be included in the bit stream are not described.

Processor 110 may have to extract the variable-size bit-strings from the bit-stream. The description of the method starts at an exemplary initial state, shown in FIG. 4A, in which registers A and B contain bit-strings Z, Y, X, W, V and T as follows:

[B/D31 . . . B/D0], [A/D31 . . . A/D0]=[T7 . . . 0, V13 . . . 0, W15 . . . 6], [W5 . . . 0, X7 . . . 0, Y9 . . . 0, Z7 . . . 0]

In box (300), processor 110 copies the value stored in register A into register C, as shown in FIG. 4B, and sets a counter Q to 0. In box (302), processor 110 extracts the bit-string that is aligned to the LSB of register C. The size of the bit-string extracted in box (302) is denoted K and counter Q is increased by the value K (302). In this state, the 8-bit bit-string [Z7 . . . 0] which is stored in [C/D7 . . . C/D0] is extracted by processor 110, so K equals 8 and counter Q equals 8.

If Q is not greater than 32 (checked in box (304)), then processor 110 performs a “double-shift Tight” operation of Q=8 bits on the registers pair [A, B] and writes the execution result to register C (306). Consequently, as shown in FIG. 4C, register C has the following content:

[C/D31 . . . C/D0]=[W13 . . . 0, X7 . . . 0, Y9 . . . 0]

It should be noted that the execution of boxes (300), (302), (304) and (306) does not alter the content of registers A and B.

The method continues to box (302), and processor 110 extracts 10-bit bit-string [Y9 . . . 0] from register C, and increases counter Q by 10 to 18. Since Q is not greater than 32 (checked in box (304)), processor 110 performs a “double-shift right” operation of Q=18 bits on the registers pair [A, B] and writes the execution result to register C (306). Consequently, as shown in FIG. 4D, register C has the following content:

[C/D31 . . . C/D0]=[V7 . . . 0, W15 . . . 0, X7 . . . 0]

The method continues to box (302), and processor 110 extracts 8-bit bit-string [X7 . . . 0] from register C, and increases counter Q by 8 to 26. Since Q is not greater than 32 (checked in box (304)), processor 110 performs a “double-shift right” operation of Q=26 bits on the registers pair [A, B] and writes the execution result to register C (306). Consequently, as shown in FIG. 4E, register C has the following content:

[C/D31 . . . C/D0]=[T1 . . . 0, V13 . . . 0, W15 . . . 0]

The method continues to box (302), and processor 110 extracts 16-bit bit-string [W15 . . . 0] from register C, and increases counter Q by 16 to 42. Since Q is greater than 32 (checked in box (304)), processor 110 copies register B into register A and the next part of the bit stream is stored in register B (308). Consequently, as shown in FIG. 4F, registers A and B have the following content:

[B/D31 . . . B/D0], [A/D31 . . . A/D0]=[R7 . . . 0, S11 . . . 0, T10 . . . 8], [T7 . . . 0, V13 . . . 0, W15 . . . 6]

The method may then proceed to box 306, where processor 110 performs a “double-shift right” operation of Q=10 bits on the registers pair [A, B] and writes the execution result to register C (306). Consequently, as shown in FIG. 4G, register C has the following content:

[C/D31 . . . C/D0]=[S6 . . . 0, T10 . . . 0, V13 . . . 0]

The method then resumes from box 302.

In a processor having two instances of shift unit 138, a bit stream of variable-size bit-strings may be processed by both instances in parallel. For example, a first instance may process two consecutive bit-strings in the bit stream while a second instance may process another two consecutive bit-strings in the bit stream.

Processor 110 may be capable of generating N-bit execution results of operations and may be incapable of generating 2N-bit execution results. However, processor 110 may have to perform operations on 2N-bit operands, and may be able to generate truncated execution results of N-bits using the “double-shift left” and “double-shift right” operations.

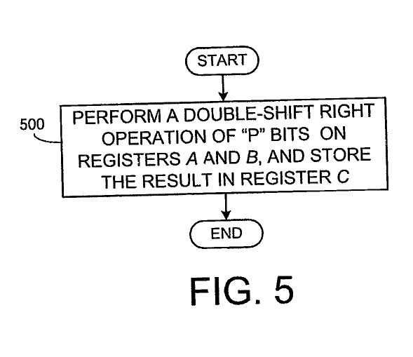

FIG. 5 presents an exemplary method, in which a “double-shift right” operation is used to generate an N-bits truncated execution result of a division of a 2N-bit operand by a number which is a power of two.

The description of the method starts at an exemplary initial state, in which registers A and B contain a 2N-bit operand “M” as follows:

[B/D31 . . . B/D0], [A/D31 . . . A/D0]=[M63 . . . M32], [M31 . . . M0]

In order to generate an N-bits truncated execution result of division of M by 2^{P}, processor 110 may perform a “double-shift right” operation of P bits on the registers pair [A, B] and may write the N least significant bits of the execution result to, for example, register C (500).

As a result, in an example in which P=3 register C may receive the following content:

C=[M34 . . . M3)

In another example, if P=10, register C may receive the following content:

C=[M41 . . . M10]

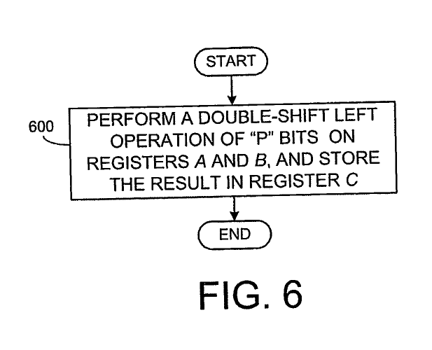

FIG. 6 presents an exemplary method, in which a “double-shift left” operation is used to generate an N-bits truncated execution result of a multiplication of a 2N-bit operand by a number which is a power of two.

The description of the method starts at an exemplary initial state, in which registers A and B contain a 2N-bit operand “M” as follows: [B/D31 . . . B/D0], [A/D31 . . . A/D0]=[M63 . . . M32], [M31 . . . M0]

In order to generate an N-bits truncated execution result of multiplication of M by 2 processor 110 may perform a “double-shift left” operation of P bits on the registers pair [A, B] and may write the N most significant bits of the execution result to, for example, register C (600).

As a result, in an example in which P=3 register C may receive the following content:

C=[M60 . . . M29]

In another example, if P=10, register C may receive the following content:

C=[M53 . . . M22]

Although embodiments of the invention have been described in the context of a processor, other embodiments of the invention include one or more instances of the shift unit described hereinabove in the context of logic circuitry that are not processors. A non-exhaustive list of examples for logic circuitry that are not processors includes a field programmable gate array (FPGA), an application specific integrated circuit (ASIC), an application specific standard product (ASSP), a dedicated or stand-alone device and the like

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

What is claimed is:

1. A processor comprising:
a first source register of a fixed number of one-bit data storage elements to store a portion of a bit-string, where a length of said bit-stting does not exceed said fixed number;
a second source register of said fixed number of one-bit data storage elements to store a complementary portion of said bit-string; and
a shift unit to output said bit-string in its entirety to a destination register of said fixed number of one-bit data storage elements.

2. The processor of claim 1, wherein said source registers are accumulators.

3. The processor of claim 1, wherein said destination register is one of said source registers.

4. The processor of claim 1, wherein said fixed data length is 32 bits.

5. The processor of claim 1, wherein said shift unit includes:
a barrel shifter of at least twice said fixed number of one-bit data storage elements to shift a concatenation of contents of said source registers by a controllable amount and to output said fixed number of bits including said bit-string in its entirety.

6. The processor of claim 5, wherein said barrel shifter is to shift said concatenation and to output said fixed number of bits including said bit-string in a single instruction cycle.

7. The processor of claim 5, wherein said barrel shifter is to shift said concatenation and to output said fixed number of bits including said bit-string in a single clock cycle.

8. The processor of claim 1, wherein said controllable amount is to be defined by software.

9. The processor of claim 7, wherein one of said source registers is to store said controllable amount in guard bits that are additional to said fixed number of bits.

10. A method comprising:
shifting a concatenation of contents of two registers having a fixed number of one-bit data storage elements by a software-defined, controllable amount; and
providing an output of said fixed number of bits from said shifted concatenation

11. The method of claim 10, wherein said registers are accumulators.

12. The method of claim 10, wherein providing said output includes providing said output to one of said registers.

13. The method of claim 10, wherein said fixed number is 32.

14. The method of claim 10, wherein shifting said concatenation and providing said output are performed in a single instruction cycle.

15. The method of claim 10, wherein shifting said concatenation and providing said output are performed in a single clock cycle.

16. The method of claim 10, wherein prior to said shifting, a first bit-string is stored in least significant bits of a first of said registers, a portion of a second bit-string is stored in most significant bits of said first of said registers and a complementary portion of said second bit-string is stored in least significant bits of a second of said registers, and wherein shifting said concatenation includes shifting said concatenation to the right by a length of said first bit-string, so that said output includes no bits of said first bit-string and all bits of said second bit-string.

17. The method of claim 10, wherein prior to said shifting a first bit-string is stored in most significant bits of a first of said registers, a portion of a second bit-string is stored in least significant bits of said first of said registers, and a complementary portion of said second bit-string is stored in most significant bits of a second of said registers, and wherein shifting said concatenation includes shifting said concatenation to the left by a length of said first bit-string, so that said output includes no bits of said first bit-string and all bits of said second bit-string.

18. A method comprising:
storing a portion of a bit-string in a first register of a fixed number of one-bit data storage elements;
storing a complementary portion of said bit-string in a second register of said fixed number of one-bit data storage elements;
shifting a concatenation of contents of said first register and said second register by a software-defined, controllable amount so that said bit-string is stored entirely in a single register of a fixed number of one-bit data storage elements.

19. The method of claim 18, wherein said amount is such that a least significant bit of said single register is a least significant bit of said bit-string.

20. The method of claim 18, further comprising:
extracting said bit-sting from said single register.

21. The method of claim 18, wherein said single register is a third register.

22. The method of claim 18, wherein said bit-string is part of a bit stream of bit strings, the method further comprising:
copying contents of said second register to said first register; and
storing subsequent bits of said bit stream in said second register.

23. A method to generate a truncated execution result of division by a power of two, the method comprising:
storing jointly in a first register of a fixed number of one-bit data storage elements and a second register of said fixed number of one-bit data storage elements an operand of twice said fixed number of bits;
shifting a concatenation of contents of said first register and said second register to the right by said power; and
selecting said fixed number of least significant bits of said shifted concatenation to generate a truncated execution result of division of said operand by said power of 2.

24. A method to generate a truncated execution result of multiplication by a power of two, the method comprising:
storing jointly in a first register of a fixed number of one-bit data storage elements and a second register of said fixed number of one-bit data storage elements an operand of twice said fixed number of bits;
shifting a concatenation of contents of said first register and said second register to the left by said power; and
selecting said fixed number of most significant bits of said shifted concatenation to generate a truncated execution result of multiplication of said operand by said power of 2.
